(19) United States
(12) Patent Application Publication
(10) Pub. No.: US 2021/0239813 A1
(43) Pub. Date: Aug. 5, 2021

(54) METHOD FOR DETERMINING AN ANGULAR POSITION OF AN OPTOELECTRONIC SENSOR, AND TEST STAND

(71) Applicant: Valeo Schalter und Sensoren GmbH, Bietigheim-Bissingen (DE)

(72) Inventors: Nikolai Sergeev, Bietigheim-Bissingen (DE); Lukasz Niestoruk, Bietigheim-Bissingen (DE); Andreas Strednicki, Bietigheim-Bissingen (DE)

(73) Assignee: Valeo Schalter und Sensoren GmbH, Bietigheim-Bissingen (DE)

(21) Appl. No.: 17/052,660

(22) PCT Filed: Apr. 29, 2019
(86) PCT No.: PCT/EP2019/060839

§ 371 Date: Nov. 3, 2020

(30) Foreign Application Priority Data
May 4, 2018 (DE) 102018110776.5

(51) Int. Cl. G01S 7/497; G01B 11/26

(52) U.S. Cl. CPC G01S 7/4972; G01S 17/931; G01B 11/26

(57) ABSTRACT

A method for determining at least one angular position of an optoelectronic sensor of a motor vehicle is disclosed. The method involves emitting light beams into surroundings of the motor vehicle by a transmitter device, receiving light beams reflected at an object by a receiver unit, wherein the light beams are represented as scan points in a sensor image of the surroundings of the motor vehicle generated by the optoelectronic sensor and each scan point is assigned to a receiver element. Two line-shaped measurement structures arranged parallel to and at a distance from one another are recognized in the sensor image for determining the at least one angular position, where at least one angular deviation of the optoelectronic sensor from a target angular position is obtained for determining the at least one angular position of the optoelectronic sensor on the basis of the scan points. Further, a test stand is also disclosed.

The invention relates to a method for determining at least one angular position of an optoelectronic sensor of a motor vehicle. Light beams are emitted into surroundings of the motor vehicle by means of the optoelectronic sensor and the light beams reflected at an object are received by a receiver unit of the optoelectronic sensor. The received light beams are represented in a sensor image by an evaluation unit. Further, the invention relates to a test stand.

The prior art has already disclosed methods for detecting misalignments of lidar sensors. Lidar sensors or laser scanners are calibrated, for example following the final assembly in a motor vehicle or in a workshop following a repair. So-called calibration targets are used for the calibration according to the prior art, as are disclosed in DE 10 2004 033 14 A1, for example. Such calibration targets have a defined form and a defined pattern made of black and white areas and are positioned in front of the vehicle for the calibration procedure.

It is an object of the present invention to develop a method and a test stand, by means of which a calibration of the optoelectronic sensor can be carried out reliably and quickly.

This object is achieved by way of a method and a test stand in accordance with the independent claims.

One aspect of the invention relates to a method for determining at least one angular position of an optoelectronic sensor of a motor vehicle. The optoelectronic sensor is used to emit light beams into surroundings of the motor vehicle. The emitted light beams are reflected at an object and received by a receiver unit with at least two receiver elements. By means of an evaluation unit, the received light beams are represented as scan points in a sensor image generated by the optoelectronic sensor. Here, each scan point is assigned to a receiver element.

At least two line-shaped measurement structures are recognized in the sensor image. The at least two line-shaped measurement structures are arranged parallel to and at a distance from one another. At least one angular deviation from the target angular position is determined for the purposes of determining the at least one angular position of the optoelectronic sensor on the basis of the scan points, which represent the first and the second measurement structure. The optoelectronic sensor is calibrated on the basis of the at least one angle deviation.

The method according to the invention allows an optoelectronic sensor to be calibrated without requiring a special calibration target. This facilitates a simple and quick calibration of the optoelectronic sensor. In particular, there is no need for calibration targets that have to be arranged at predefined positions in the surroundings of the motor vehicle. Instead, use can be made of objects which are represented in the sensor image as line-shaped, parallel and spaced apart measurement structures.

At least two planes are defined in the sensor image as a result of the assignment of the scan points to the at least two receiver elements. So that an object in the sensor image counts as a line-shaped measurement structure within the meaning of the invention, the scan points which are assigned to the object in the sensor image must be able to be connected with a single continuous line across planes. In particular, the continuous line can be a straight line. Alternatively, the line can also be a curve. To determine the angular position of the optoelectronic sensor, at least two measurement structures, which each meet these requirements and, moreover, are arranged parallel to and at a distance from one another, are recognized in the sensor image.

Consequently, it is possible to determine the at least one angular position of the optoelectronic sensor, in particular relative to the motor vehicle, by means of the method according to the invention. In particular, this allows a misalignment of the optoelectronic sensor to be recognized and be corrected by means of the evaluation unit such that an improved operation of the optoelectronic sensor is facilitated.

According to one configuration, a sensor coordinate system is formed in the generated sensor image using at least two received scan points of the first receiver element. Additionally, a reference coordinate system is determined using at least one scan point of the first receiver element and at least one scan point of the second receiver element. Here, the scan points that determine the sensor coordinate system and the scan points that form the reference coordinate system are assigned to the same of the at least two measurement structures in the sensor image. The at least one angular deviation of the optoelectronic sensor from the target angular position is determined, for the purposes of determining the at least one angular position of the optoelectronic sensor, by a comparison of the sensor coordinate system with the reference coordinate system. As a result, an angular position of the optoelectronic sensor can be determined reliably.

In a further embodiment, a yaw angle is determined as angular deviation of the optoelectronic sensor. In particular, the yaw angle, also referred to as “yaw”, can be a rotation of the optoelectronic sensor about a vertical axis of the motor vehicle. By determining the angular deviation as a yaw angle, it is possible, in particular, to determine the rotation about the vertical axis of the optoelectronic sensor and, in particular, it is possible to calibrate or correct this angular deviation of the optoelectronic sensor such that it is possible to provide a sensor image of the optoelectronic sensor that has been corrected for this yaw angle.

In a further embodiment, a pitch angle is determined as angular deviation of the optoelectronic sensor. In particular, the pitch angle, also referred to as “pitch”, can be a rotation of the optoelectronic sensor about a transverse axis of the motor vehicle. By determining the angular deviation as a pitch angle, it is possible, in particular, to determine the rotation about the transverse axis of the optoelectronic sensor and, in particular, it is possible to calibrate or correct this angular deviation of the optoelectronic sensor such that it is possible to provide a sensor image of the optoelectronic sensor that has been corrected for this pitch angle.

According to a further embodiment, the yaw angle and the pitch angle are determined as respective angular deviation, wherein the yaw angle is determined on a first processor core of the optoelectronic sensor and the pitch angle is determined on a second processor core of the optoelectronic sensor. Consequently, the yaw angle and the pitch angle can be determined in parallel on different processor cores. In particular, the evaluation unit is then able to carry out a correction or a calibration of the optoelectronic sensor on the basis of the respectively determined yaw angle/pitch angle by way of the processor cores. As a result, the yaw angle and the pitch angle can be determined simultaneously in reliable and quick fashion such that the calibration of the optoelectronic sensor can be carried out reliably and securely.

In one embodiment, the angular deviation of the optoelectronic sensor from a target angular position between at least one scan axis and a reference axis of the optoelectronic sensor is determined for the purposes of determining the at least one angular position. The scan axis is formed by at least one scan point of the first measurement structure and by at least one scan point of the second measurement structure. Using this embodiment, a roll angle can advantageously be determined as angular deviation of the optoelectronic sensor. In particular, the roll angle, also referred to as “roll”, can be a rotation of the optoelectronic sensor about a longitudinal axis of the motor vehicle. By determining the roll angle, in particular the rotation determined about this longitudinal axis of the optoelectronic sensor, it is possible to calibrate or correct this angular position of the optoelectronic sensor such that it is possible to provide the sensor image of the optoelectronic sensor that has been corrected for this roll angle.

According to a further advantageous embodiment, the yaw angle is determined as first angular deviation and the pitch angle is determined as second angular deviation and the roll angle is determined as third angular deviation after the determination of the yaw angle and/or of the pitch angle. Since, in particular, the roll angle is dependent on the yaw angle and/or the pitch angle, the roll angle can be determined very reliably by determining the pitch angle and the yaw angle before the roll angle is determined. In particular, it is consequently possible to quickly and reliably determine any misalignment of the optoelectronic sensor and the optoelectronic sensor can be calibrated.

In a further embodiment, the motor vehicle is at a standstill while the angular position is determined. By way of example, following the final assembly or during a workshop visit, the motor vehicle can be driven into surroundings with at least two line-shaped measurement structures and can be brought to a standstill. Subsequently, the optoelectronic sensor can be calibrated using the measurement structures. An exact alignment of the motor vehicle relative to the measurement structures is not necessary in this case. By determining the angular position of the optoelectronic sensor at a standstill, it is possible to determine the angular position independently of the influences of the surroundings, such as vibrations generated by the motor. Consequently, the angular position can be reliably determined.

In a further embodiment, the motor vehicle is in motion while the angular position is determined. Expressed differently, the motor vehicle is in motion relative to the at least two line-shaped measurement structures during the determination. In the process, the vehicle can be under manual control by a driver or under autonomous control. Alternatively, the vehicle can also be moved on a conveyor belt relative to the measurement structures. By moving the vehicle relative to the measurement structure, it is possible to determine the at least one angular position of the optoelectronic sensor, in particular as a mean value over a multiplicity of measurements from different viewing angles.

In a further embodiment, the at least two line-shaped measurement structures that are arranged parallel to and at a distance from one another are at least two markings applied to a ground on which the motor vehicle is situated. By way of example, materials or colours that are also used for road markings can be used as markings. In particular, these colours are materials can contain highly reflective particles such that the markings can be captured particularly well. Additionally, such markings can be applied with little outlay on the ground, both in a workshop and in an assembly shop.

In a further embodiment, at least two parallel walls are captured as line-shaped, parallel and spaced apart measurement structures in the surroundings. The two parallel walls could be outer walls of the workshop or an assembly hall, or else wall-like structures, which are arranged parallel to and at a distance from one another. By way of example, a wooden board or a metal plate can be considered for the wall-like structure. The parallel walls can additionally be coated by a reflective layer. As a result of the use of parallel walls, the method can be carried out safely and reliably, even under simple conditions.

A further aspect of the invention relates to a test stand for determining at least one angular position of an optoelectronic sensor of a motor vehicle. The test stand comprises a first line-shaped measurement structure and at least one second line-shaped measurement structure, which are arranged at a distance from and parallel to one another.

In one embodiment, the first and the second line-shaped measurement structure is a marking on a ground in the surroundings of the motor vehicle.

In a further embodiment, the first line-shaped measurement structure and the second line-shaped measurement structure are parallel, spaced apart walls in the surroundings of the vehicle. In particular, these can be walls of an assembly shop or a workshop. Alternatively, the walls can be boards made of wood, metal or the like, which are arranged parallel to one another. Furthermore, the walls can be coated with a reflective material.

Further features of the invention emerge from the claims, the figures and the description of the figures. The features and combinations of features that are cited in the description above, and also the features and combinations of features that are cited in the description of the figures below and/or as shown in the figures alone, can be used not only in the respectively indicated combination but also in other combinations or on their own without departing from the scope of the invention. Embodiments of the invention that are not explicitly shown and explained in the figures, but emanate and are producible from the explained embodiments by virtue of self-contained combinations of features, are therefore also intended to be regarded as included and as disclosed. Embodiments and combinations of features are also considered to be disclosed which therefore do not have all the features of an originally formulated independent claim. Embodiments and combinations of features that go beyond or differ from the combinations of features set out in the back-references of the claims, should furthermore be considered to be disclosed, in particular by the embodiments set out above.

The invention will now be explained in more detail on the basis of preferred exemplary embodiments and with reference to the attached drawings.

### IN THE FIGURES

FIG. 1 shows a schematic plan view of a motor vehicle comprising an embodiment of an optoelectronic sensor;

FIG. 2 shows a schematic view of an embodiment of a test stand;

FIG. 3 shows a first schematic view of an embodiment for determining an angular position;

FIG. 4 shows a second schematic view of an embodiment for determining an angular position; and

FIG. 5 shows a third schematic view of an embodiment for determining a further angular position.

The same reference signs are given in the figures to identify elements that are identical and have the same functions.

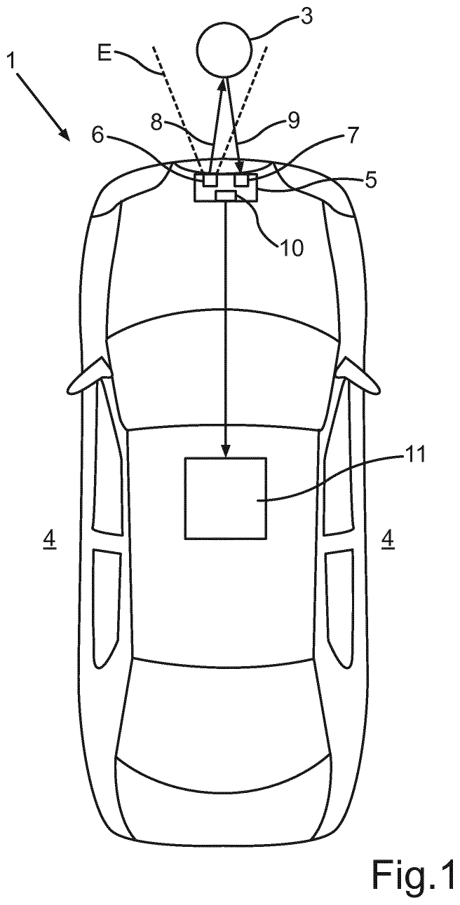

FIG. 1 shows a motor vehicle 1 comprising a driver assistance system 2. An object 3 that is located in surroundings 4 of the motor vehicle 1, for example, can be captured by the driver assistance system 2. In particular, a distance between the motor vehicle 1 and the object 3 can be determined by means of the driver assistance system 2.

The driver assistance system 2 comprises at least one optoelectronic sensor 5. The optoelectronic sensor 5 can be embodied as a lidar sensor or laser scanner. In the present case, the optoelectronic sensor 5 is arranged at a front region of the motor vehicle 1. The optoelectronic sensor 5 can also be arranged in other regions, for example at a rear region or at a side region of the motor vehicle 1.

The optoelectronic sensor 5 comprises a transmitter device 6, by means of which light beams 8 can be emitted or sent out. The light beams 8 can be emitted by the transmitter device 6 within a predetermined capture range E or a predetermined angular range. By way of example, the light beams 8 can be emitted in a predetermined horizontal angular range. Moreover, the optoelectronic sensor 5 comprises a deflection device, this deflection device not being depicted, by means of which the light beams 8 can be deflected into the surroundings 4 and hence the capture region E is scanned.

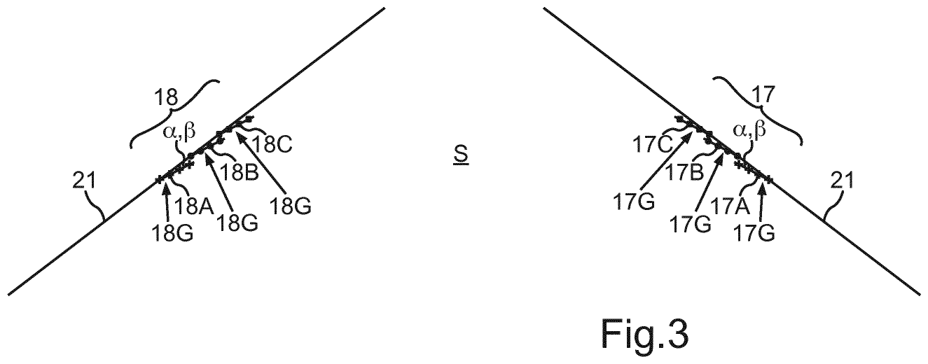

Moreover, the optoelectronic sensor 5 comprises a receiver unit 7, which may comprise at least two receiver elements, for example. Using a receiver unit 7, the light beams 9 reflected by the object 3 can be received as a reception signal. Further, the optoelectronic sensor 5 can comprise a control device, which may be formed by a microcontroller or digital signal processor, for example. The optoelectronic sensor 5 can comprise an evaluation unit 10, by means of which the received reflected light beams 9 can be represented as scan points 17, 18, 19, 20 (see FIG. 3) in a sensor image of the optoelectronic sensor 5. The driver assistance system 2 further comprises a control device 11 that can be formed, for example, by an electronic control unit (ECU) of the motor vehicle 1. The control device 11 is connected to the optoelectronic sensor 5 for data transfer. The data transfer can be implemented, for example, via the data bus of the motor vehicle 1.

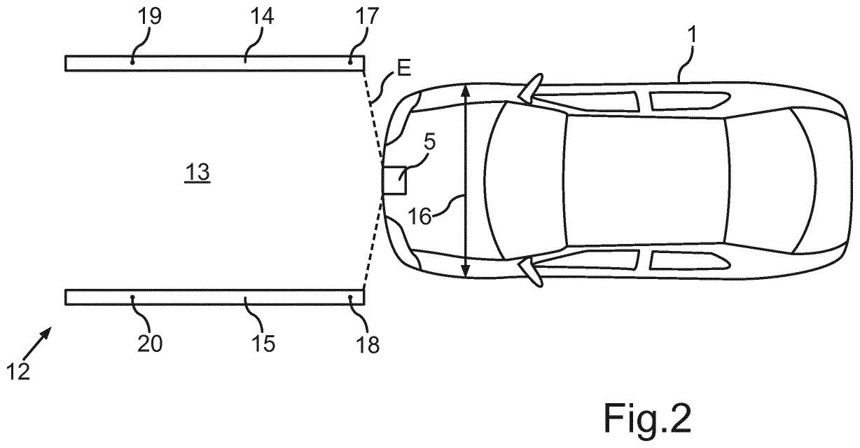

FIG. 2 shows a schematic plan view of an embodiment of the test stand 12 according to the invention in a test area 13. The test area 13 is the area in an assembly hall or in a workshop in which the test stand 12 is arranged and in which the vehicle is positioned or moved. The test stand 12 has two markings as line-shaped measurement structures 14, 15, which are arranged on a ground. The markings 14, 15 are applied parallel to and at a distance from one another on the ground. The markings consist of paint containing highly reflective particles. The motor vehicle 1 is positioned in front of the test stand 12 in the test area 13 in such a way that the optoelectronic sensor 5 arranged in the front of the motor vehicle 1 is able to capture the markings. The motor vehicle 1 is at a standstill for the purposes of calibrating the optoelectronic sensor 5.

FIG. 3 shows a schematic perspective view of a sensor image S of the optoelectronic sensor 5 when capturing a test stand as per FIG. 2. In the present exemplary embodiment, the optoelectronic sensor 5 comprises three receiver elements of the receiver unit 7, by means of which light beams reflected at an object can be captured. The captured reflected light beams are represented by the evaluation unit 10 as scan points 17, 18 in the sensor image of the optoelectronic sensor 5. The three receiver element define three mutually separated planes in the sensor image. Represented within one plane are the reflected light beams which were captured from different horizontal angles relative to the optoelectronic sensor 5 with captured by the respective receiver element. The scan points 17 represent the first marking in the sensor image, wherein the scan points 17A are imaged in the first plane of the sensor image, the scan points 17B are imaged in the second plane and the scan points 17C are imaged in the third plane. The scan points 18 represent the first marking in the sensor image, wherein the scan points 18A are imaged in the first plane of the sensor image, the scan points 18B are imaged in the second plane and the scan points 18C are imaged in the third plane. To determine the angular position of the optoelectronic sensor 5 relative to the motor vehicle 1, an angular deviation from a target angular position is determined by comparison of a sensor coordinate system with a reference coordinate system. The sensor coordinate system is formed by a scan point straight line 17G, 18G. For each plane in the sensor image, is through all scan points 17, 18, which are assigned to a marking. The scan point straight lines 17G, 18G which are assigned to a marking are parallel to one another. The reference coordinate system is formed by a reference straight line 21. The reference straight line 21 is placed through scan points of the three planes that have the same horizontal angle. If the angular position of the optoelectronic sensor 5 corresponds to the target angular position, the scan point straight lines 17G, 18G and the reference straight line 21 extend parallel to one another. If the scan point straight lines 17G, 18G and the reference straight line 21 have points of intersection, an angular deviation of the optoelectronic sensor 5 is determined as an angle between the scan point straight lines 17G, 18G and the reference straight line. The yaw angle α and/or the pitch angle β is/are determined as an angular deviation in this way.

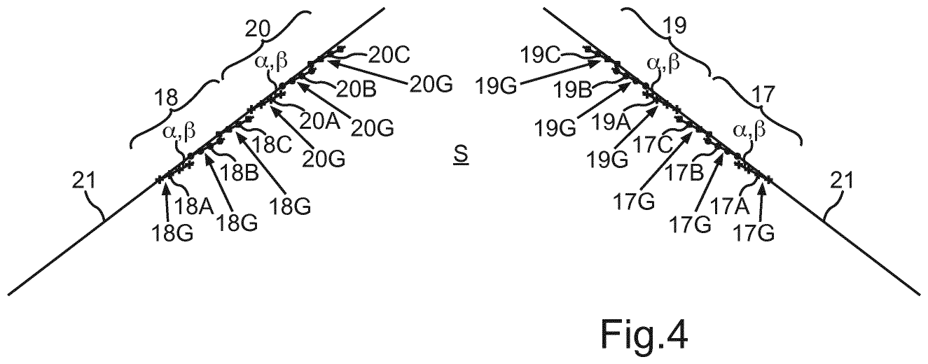

FIG. 4 shows a schematic perspective view of a sensor image S of the optoelectronic sensor 5, wherein the sensor image is constructed on the basis of two different measurements, which were recorded in succession, and the vehicle was moved between the measurements. The scan points 17, 18 were recorded during the first measurement and the scan points 19, 20 were recorded during the second measurement. The scan points 17, 18, 19, 20 are evaluated in a manner analogous to the evaluation described in relation to FIG. 3. In this way, the yaw angle α and/or the pitch angle β is determined as an angular deviation using two measurements with different perspectives on the markings. The yaw angle α and/or the pitch angle β as an angular deviation are respectively determined as a mean value of the individual values for the yaw angle α and/or the pitch angle β from the two measurements.

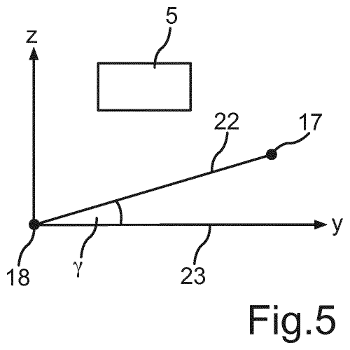

FIG. 5 shows a schematic transverse view for determining the roll angle γ as angular deviation. The roll angle γ is a rotation about the vehicle longitudinal axis X. For the purposes of determining the roll angle γ, the angle between a scan axis 22 and a reference axis 23 is determined. The scan axis 22 is formed by a straight line which is placed through a scan point 17, which is assigned to the first marking, and a scan point 18, which is assigned to the second marking. The reference axis 23 is aligned parallel to the ground. If the angular position of the optoelectronic sensor 5 corresponds to the target angular position, the scan axis 22 and the reference axis 23 are parallel to one another. If the scan axis 22 and the reference axis 23 have a point of intersection, the angle between the scan axis 22 and the reference axis 23 corresponds to the roll angle γ. To allow the roll angle γ to be determined reliably, the yaw angle α and/or the pitch angle β must be determined in a previous step.

Depending on the angular deviations determined, the optoelectronic sensor 5 is calibrated or corrected. To this end, the evaluation unit 10 of the optoelectronic sensor 5 can determine the yaw angle α, the pitch angle β and the roll angle γ and can calibrate the optoelectronic sensor 5. Then, during driving operation, the sensor image is corrected for the corresponding angle deviations by the evaluation unit 10.

1. A method for determining at least one angular position of an optoelectronic sensor of a motor vehicle, wherein the optoelectronic sensor comprises at least one transmitter device, at least one receiver unit with at least two receiver elements, and at least one evaluation unit, the method comprising:
emitting light beams into surroundings of the motor vehicle by the transmitter device,
receiving light beams reflected at an object by the receiver unit, wherein the light beams are represented by the evaluation unit as scan points in a sensor image of the surroundings of the motor vehicle generated by the optoelectronic sensor, and each scan point is assigned to a receiver element,
recognizing at least two line-shaped measurement structures arranged parallel to and at a distance from one another in the sensor image for determining the at least one angular position,
wherein at least one angular deviation of the optoelectronic sensor from a target angular position is determined for the purposes of determining the at least one angular position of the optoelectronic sensor on the basis of the scan points (17, 18, 19, 20), which represent the least two measurement structures, and
wherein the optoelectronic sensor is calibrated on the basis of the at least one angular deviation.

2. The method according to claim 1, wherein a sensor coordinate system is determined in the generated sensor image using at least two received scan points of the first receiver element, and a reference coordinate system is determined in said generated sensor image using at least one scan point of the first receiver element and at least one scan point of the second receiver element,
wherein the scan points, which determine the sensor coordinate system and the scan points which form the reference coordinate system are assigned to the same of the at least two measurement structures in the sensor image, and
the at least one angular deviation of the optoelectronic sensor from the target angular position is determined, for the purposes of determining the at least one angular position of the optoelectronic sensor, by a comparison of the sensor coordinate system with a reference coordinate system.

3. The method according to claim 2, wherein a yaw angle of the optoelectronic sensor is determined as angular deviation.

4. The method according to claim 2, wherein a pitch angle of the optoelectronic sensor is determined as angular deviation.

5. The method according to claim 1, wherein the angular deviation of the optoelectronic sensor from a target angular position between at least one scan axis and a reference axis of the optoelectronic sensor is determined for the purposes of determining the angular position, wherein the scan axis is formed by at least one scan point of one of the at least two measurement structures and at least one scan point the other of the at least two measurement structures.

6. The method according to claim 5, wherein a roll angle of the optoelectronic sensor is determined as angular deviation.

7. The method according to claim 1, wherein a yaw angle is determined as a first angular deviation and/or a pitch angle is determined as a second angular deviation and a third angular deviation is determined as roll angle after the determination of the yaw angle and/or the pitch angle.

8. The method according to claim 1, wherein the motor vehicle is at a standstill when the angular position is determined.

9. The method according to claim 1, wherein the motor vehicle is in motion while the angular position is determined.

10. The method according to claim 1, wherein at least two markings on a ground, on which the motor vehicle is situated, are captured as parallel measurement structures in the surroundings.

11. The method according to claim 1, wherein at least two parallel walls are captured as parallel measurement structures in the surroundings.

12. A test stand for determining at least one angular position of an optoelectronic sensor of a motor vehicle, comprising: at least one first line-shaped measurement structure and at least one second line-shaped measurement structure, which are arranged at a distance from and parallel to one another.

13. The test stand according to claim 12, wherein the first line-shaped measurement structure and the second line-shaped measurement structure are parallel, spaced apart markings on a ground in the surroundings of the motor vehicle.

14. A test stand according to claim 12, wherein the first line-shaped measurement structure and the second line-shaped measurement structure are parallel, spaced apart walls in the surroundings of the motor vehicle.
